(19) United States
(12) Patent Application Publication
(10) Pub. No.: US 2015/0104638 A1
(43) Pub. Date: Apr. 16, 2015

(54) REINFORCED MOULDINGS, METHOD FOR THE PRODUCTION THEREOF, AND THE USE THEREOF

(71) Applicant: EMS-PATENT AG, Domat/Ems (CH)

(72) Inventors: Thomas JELTSCH, Domat/Ems (CH); Bernd HENKELMANN, Bonaduz (CH)

(21) Appl. No.: 14/504,651

(22) Filed: Oct. 2, 2014

(30) Foreign Application Priority Data
Oct. 11, 2013 (EP) 13 188 305.0

(51) Int. Cl. B29C 45/14

(52) U.S. Cl. CPC B29C 45/14065; B29C 2045/14163; B29K 2077/00
USPC 428/338; 264/275; 428/221

(57) ABSTRACT

The invention relates to a method for the production of mouldings reinforced with fibre ribbons and also to correspondingly reinforced mouldings. In addition, the invention relates to uses of the mouldings produced via the method.

### CROSS-REFERENCE TO A RELATED APPLICATION

This application claims the benefit of European Patent Application No. 13 188 305.0, filed Oct. 11, 2013, the disclosure of which is incorporated herein by reference.

### FIELD OF THE INVENTION

The invention relates to a method for the production of mouldings reinforced with fibre ribbons and also to correspondingly reinforced mouldings. In addition, the invention relates to uses of the mouldings produced via the method.

### BACKGROUND OF THE INVENTION

Because of endeavours to replace metals by plastic materials, higher and higher demands are made on the mechanical properties thereof. A current procedure for improving the mechanical properties resides in introducing fibrous reinforcing materials, such as e.g. glass- or carbon fibres, into the plastic material matrix. Even components made of a plastic material reinforced in this way have however often significantly lower rigidities than metal components.

A further improvement can be achieved by selective reinforcement of the mouldings with fibre ribbons. This is achieved for example by specific application or introduction of these fibre ribbons on or into the moulding. One of the most important methods for the production of plastic material mouldings is represented by the injection moulding process. For economic reasons, it is desirable to apply the fibre ribbon or ribbons into the moulding, into or onto the latter, even during the injection moulding process and not to add a separate step subsequently.

From DE 10 2011 077 834 A1, a method for the production of a fibre composite structural part by injection moulding or transfer moulding is known. A prefabricated semifinished product is thereby placed in an injection moulding die and, after the die is closed, a fibre-reinforced plastic material is injected in. The secure position of the semifinished product in the die is thereby ensured by clamping elements.

Another method for the production of injection moulded components partially reinforced with endless fibres is described in DE 10 2007 037 680 A1. A special die mould is used here which allows introduction of needles into the die mould. With these needles, an endless fibre semifinished product is positioned in the die mould before injection of a thermoplastic material. After the injection, the needles are retracted.

DE 10 2011 120 986 A1 describes an injection moulding method for manufacture of a fibre composite hollow profile component with moulded-on shaped- and/or functional structures. In a first die, a core is hereby cast firstly and is then covered by a fibre material saturated in a duroplastic. In a second die, this covered core is hardened at least partially and functional- or shaped structures are moulded on. After removal of the hollow profile from the mould, the core is heated at least to its melting temperature and melted out of the hollow profile.

### BRIEF SUMMARY OF THE INVENTION

Starting hereform, it was the object of the present invention to provide a method for the production of thermoplastic mouldings reinforced with fibre ribbons, which method enables secure fixing of the fibre ribbons during the injection moulding process. Furthermore, is was the object of the present invention to provide a method which is simple with respect to apparatus and makes the use of specially modified injection moulding dies superfluous.

This object is achieved by the mouldings described herein, the method for the production of mouldings reinforced with fibre ribbons having the features described herein, advantageous developments thereof, and uses thereof.

### BRIEF DESCRIPTION OF THE SEVERAL VIEWS OF THE DRAWING(S)

FIG. 1 shows the ejector side of a mould half of the injection moulding die.

FIG. 2 shows the construction of a perform.

FIG. 3 shows insertion of a preform into an injection moulding die.

FIG. 4 shows a preform placed in an injection moulding die.

FIG. 5 shows the construction of a moulding produced according to the invention.

FIGS. 6a-c show possible constructions of mountings. FIG. 6a shows a mounting with prestressed linkages. FIG. 6b shows a mounting with lateral support arms pre-bent towards the outside. FIG. 6c shows a mounting placed in the injection moulding die.

FIG. 7 shows the construction of an expanding wedge which can be produced via injection moulding- or rapid prototyping methods.

FIG. 8 shows the construction of an expanding wedge which can be produced via extrusion methods.

### DETAILED DESCRIPTION OF THE INVENTION

According to the invention, a method for the production of a moulding having at least one reinforcement by means of fibres which are orientated unidirectionally and embedded in a first plastic material matrix is provided, comprising the following steps:
a) Providing a preform comprising at least one fibre ribbon, a mounting being fitted in the longitudinal direction of the at least one fibre ribbon at one end and, at the other end, at least one fixing unit which is moveable along the longitudinal direction of the at least one fibre ribbon being fitted,
b) Inserting and fixing the preform in an injection moulding die, the end with the mounting being disposed at the outflow end of the injection moulding die,
c) Injecting a second plastic material matrix through the melt channel so that the fixing unit is transported by the melt flow to the other end of the preform and also
d) Cooling and hardening the moulding.

It is thereby preferred that the fixing unit is disposed such that the at least one fibre ribbon abuts against an inner side face of the injection moulding die and the fixing unit is guided during the injection such that the second plastic material matrix and the at least one fibre ribbon are connected to each other over the whole surface and in a planar manner and the fibre ribbon forms a surface of the moulding at least in regions.

A further preferred embodiment provides that the fixing unit is disposed such that two fibre ribbons abut against oppositely situated inner side faces of the injection moulding die and the fixing unit is guided during the injection such that the second plastic material matrix and the fibre ribbons are connected to each other over the whole surface and in a planar manner and the two fibre ribbons form oppositely situated surfaces of the moulding at least in regions.

Furthermore, it is preferred that the fixing unit is fitted in the first half, particularly preferably in the first third of the longitudinal portion of the fibre ribbons which is situated opposite the end with the mounting. It is particularly preferred to fit the fixing unit at the end of the preform.

The first plastic material matrix of the fibre ribbons and/or the second plastic material matrix to be injected is selected preferably from the group consisting of thermoplastics and duroplastics and/or mixtures thereof, thermoplastics being preferred.

If the first plastic material matrix and/or the second plastic material matrix is a thermoplastic, this is selected preferably from the group consisting of acetal resins, liquid-crystalline polymers, polyacrylates, polymethacrylates, olefinic and cycloolefinic polymers, polyamides, polyamide elastomers, in particular polyester amides, polyether amides and polyether ester amides, polyamide imides, polyarylethers comprising polyphenylethers, polycarbonates, polysulphones, polyetherimides, polyimides, polyesters, polyester polycarbonates, polyethers, polyoxyethylenes, polystyrene, polysulphones, vinyl polymers such as polyvinylchloride and polyvinylacetate, or mixtures of one or more of the listed materials, in particular ABS, MBS, SAN, PC and PMMA.

The thermoplastic first and/or second plastic material matrix preferably has melting points of 50 to 500° C., preferably of 170 to 400° C. and particularly preferred of 170 to 350° C. and/or a glass transition temperature in the range of 30 to 250° C., preferably in the range of 30 to 170° C., particularly preferred in the range of 35 to 135° C.

There are used as thermoplastic first and/or second plastic material matrix, preferably matrices made of polyamide. The polyamides are thereby obtained preferably from aliphatic, including cycloaliphatic, diamines and aromatic or aliphatic dicarboxylic acids or from lactams. For particular preference, homo- and copolyamides formed from cycloaliphatic C6-C17 diamines and/or aliphatic C4-C12 diamines with aliphatic C4-C20 dicarboxylic acids and/or aromatic dicarboxylic acids are used.

Special non-limiting examples of the dicarboxylic acids are succinic acid, glutaric acid, adipic acid, pimelic acid, suberic acid, azelaic acid, sebacic acid, undecanedioic acid, dodecanedioic acid, brassylic acid, tetradecanedioic acid, 1,4-cyclohexanedicarboxylic acid, icosanedioic acid, naphthalenedicarboxylic acid, terephthalic acid and isophthalic acid.

Alternatively, also polyamides are preferred which are formed from the previously mentioned diamines and dicarboxylic acids and also lactams with 4 to 15 C atoms and/or, ω amino acids with 4 to 15 C atoms.

Special, non-limiting examples of the diamines are hexamethylene diamine, heptamethylene diamine, octamethylene diamine, nonamethylene diamine, decamethylene diamine, undecamethylene diamine, dodecamethylene diamine, trimethylhexamethylene diamine, 2-methyl-1,5-pentane diamine, isophorone diamine, norbornane diamine, 1,3-bis(aminomethyl)cyclohexane, MACM, MXD, PACM, PXD and TMACM.

MACM stands for 3,3′-dimethyl-4,4′-diaminocyclohexylmethane, MXD stands for meta-xylylenediamine, PACM stands for 4,4′-diaminocyclohexylmethane, PXD stands for para-xylylenediamine and TMACM stands for 3,3′,5,5′-tetramethyl-4,4′-diaminocyclohexylmethane.

Furthermore, polyamides made of MXD and terephthalic acid, or MXD and isophthalic acid are preferred.

Preferred transparent polyamides are selected from the group: MACM9-18, PACM9-18, MACMI/12, MACMI/MACMT, MACMI/MACMT12, 6I6T/MACMI/MACMT/12, 3-6T, 6I6T, 6I/MACMI/MACMT, 6I/PACMI/PACMT, 6I/6T/MACMI, MACMI/MACM36, 6I, 12/PACMI, MXDI/6I or 12/MACMT, 6/PACMT, 6/6I, 6I/PDT or mixtures thereof, 50% by mol of IPS being able to be replaced by TPS.

Furthermore, partially crystalline polyamides, selected from the group consisting of PA6, PA66, PA69, PA610, PA612, PA11, PA12, PA1010, PA1012, PA1210, PA1212 are preferred. Particularly preferred are PA12 and mixtures of PA66 and PA6I/6T.

It is preferred if the first plastic material matrix has a lower melting point than the second plastic material matrix. Preferably, the melting point of the first plastic material matrix is lower by 1 to 300° C., preferably by 20 to 150° C., than that of the second plastic material matrix.

If the first and/or second plastic material matrix is a duroplastic, this is selected preferably from the group consisting of melamine resins, phenoplastics, polyester resins, aminoplastics, epoxy resins, polyurethanes, crosslinked polyacrylates and/or mixtures or blends thereof.

Also the second plastic material matrix, in a preferred embodiment, is fibre-reinforced, preferably it is reinforced with carbon- or glass fibres with a flat or round cross-section. Hereby preferred are fibres with a length of 0.1 to 50 mm and a diameter of 5 to 40 μm. The proportion of reinforcing materials for carbon fibres is from 3 to 50% by weight, preferably 5 to 40% by weight and for glass fibres, 5 to 75% by weight, preferably from 15 to 65% by weight and particularly preferred from 30 to 50% by weight, respectively relative to the total mass of the second plastic material matrix and of the optionally present further additives.

However, it is also possible to use non-reinforced plastic material matrices.

The first and/or second plastic material matrix can have preferably further additives. These are preferably selected from the group consisting of inorganic stabilisers, organic stabilisers, lubricants, defoamers, chain-lengthening additives, optical brighteners, plasticisers, adhesives, halogen-containing flame retardants, halogen-free flame retardants, impact modifiers, particles, fillers and reinforcing materials, colourants, pigments and/or mixtures thereof.

The proportion of further additives is preferably 0.1 to 20% by weight and particularly preferred 0.5 to 10% by weight, relative to the total mass of the first and/or second plastic material matrix and of the reinforcing materials.

Preferably, an expanding wedge is used as fixing unit. Any type of fixing unit which, on the one hand, ensures secure retention of the fibre ribbons from the time of injection until hardening of the second plastic material matrix and which, on the other hand, is transported by the second plastic material matrix to the opposite end of the fibre ribbon for mounting is according to the invention. For example plug-, block- or arrow-shaped fixing units which comprise spring elements in preferred embodiments are conceivable.

The mounting and the fixing unit used to produce the preform can consist of all the materials which were mentioned already for the first and/or second plastic material matrix, also the already mentioned polyamides are the preferred materials for the mounting and the fixing unit.

In a preferred embodiment, the mounting and the fixing unit are produced from identical materials. Furthermore, it is preferred that mounting and fixing unit have the same or a lower melting point than the second plastic material matrix. It is thereby preferred that the melting point of mounting and fixing unit is lower by 0 to 300, preferably by 20 to 150° C., particularly preferred 40 to 130° C., than of the second plastic material matrix.

In a particularly preferred embodiment, the mounting and the fixing unit are produced from the same material, it is particularly preferred to choose the same material for the mounting, the fixing unit and the second plastic material matrix.

The mounting and the fixing unit are produced preferably via rapid prototyping-, extrusion-, injection moulding methods or machining methods.

Preferably, the fibres are endless fibres or staple fibres, in particular carbon-, glass-, mineral- or aramide fibres. Here, carbon- and glass fibres with a flat or round cross-section are particularly preferred, particularly preferred are carbon fibres. Also mixtures of the mentioned fibres can be used.

The proportion of fibres in the fibre ribbons is preferably 1 to 60% by weight, particularly preferred 5 to 50% by weight and in particular preferred 10 to 40% by weight, relative to the total mass of the fibre ribbon.

The thickness of the fibre ribbons is preferably from 0.1 to 5 mm, preferably from 0.2 to 2.0 mm and particularly preferred from 0.2 to 1.0 mm. The width of the fibre ribbons is preferably from 1 to 40 mm, preferably from 2 to 20 mm and particularly preferred from 5 to 15 mm.

The fibre ribbons can be moulded onto the upper and lower side or also only on one of the two sides. In addition, the moulding can extend over the complete surface or be restricted to parts of the surface.

According to the thickness of the moulding, also a plurality of fibre ribbons can be disposed one next to the other. In addition, it is possible to use laminates made of fibre ribbons. These laminates are used preferably for more complex geometries, such as e.g. spirals, curved or S-shaped structures.

A preferred embodiment provides a preform made of 2 fibre ribbons.

In a further preferred embodiment, the fibre ribbons in the preform are positioned at a spacing of 0.1 to 100 mm, preferably of 0.3 to 30 mm and particularly preferred of 1 to 10 mm relative to each other.

It is possible by suitable design of the moveable fixing unit also to design preforms in which the spacing of the fibre ribbons is not uniform over the complete path length. In a preferred embodiment, the expanding wedge is thereby designed to be V-shaped and the opening angle is adapted reversibly to the spacing of the fibre ribbons.

In addition, it is possible to use fibre ribbons or laminates made of fibre ribbons with more complex geometries, such as e.g. spirals, or S-shaped structures. It is preferred to use fibre ribbons with a flat geometry.

The preform is fixed in the die by clamping or gluing the mounting or by suctioning the mounting by vacuum. For preference, the preform should be clamped in.

The at least one fixing unit is guided preferably by 2 fibre ribbons during injection of the plastic material matrix. In variants in which only one fibre ribbon is used, the fixing unit is guided by the fibre ribbon and a wall of the die. The fixing unit is transported by the melt flow to the opposite end of the fibre ribbon and comes to lie in front of the mounting.

Optionally, the part of the moulding, in which the fixing unit comes to lie and in which the mounting is situated, can be separated. Separation can be effected by cutting, laser treatment, squeezing, sawing, water jets, bending or combinations of these measures.

A further variant of the method according to the invention provides using materials having the same or a lower melting point of 0 to 300° C., preferably 20 to 150° C. for the mounting and the fixing unit. The connection piece and the fixing unit can be integrated then in the moulding simply after injection of the plastic material matrix by melting.

According to the invention, a fibre-reinforced injection moulding is likewise provided, which comprises at least one fibre ribbon made of fibres which are embedded unidirectionally in a first plastic material matrix and also at least one second plastic material matrix, at least one surface of the moulding being formed from the at least one fibre ribbon at least in regions.

Preferably, the moulding, on two oppositely situated surfaces, has respectively at least one fibre ribbon at least in regions, the spacing of the fibre ribbons relative to each other being the same or different and preferably being in the range of 0.1 to 100 mm, preferably 0.3 to 30 mm and particularly preferred 1 to 10 mm.

The moulding according to the invention is produced preferably according to the previously described method.

The reinforced mouldings according to the invention are used in particular as:
Automobile parts, preferably running gear components, struts, interior parts, exterior parts, transmission components and rims;
Industrial and consumer goods, preferably levers, fixings, garden appliances, tools, household appliances, sanitary components, racquets, bows and footwear.

The subject according to the invention is intended to be described in more detail with reference to the following Figures without wishing to restrict said subject to the specific embodiments shown here.

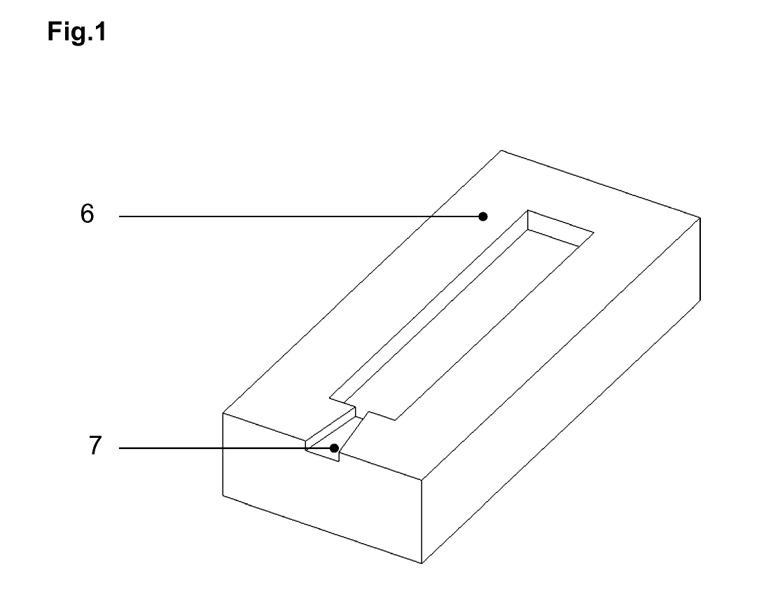

FIG. 1 shows, with reference to a schematic illustration, the ejector side of a mould half of the injection moulding die 6. The second plastic material matrix 8 is introduced through the melt channel 7 into the injection moulding die 6.

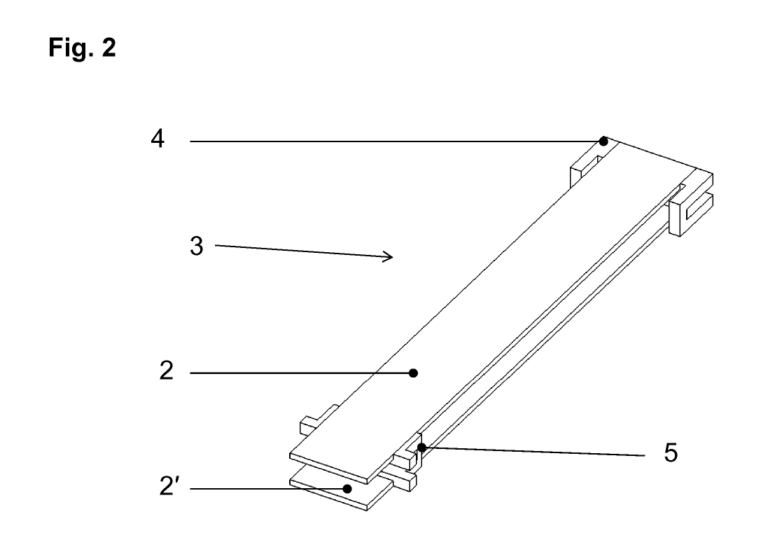

FIG. 2 shows, with reference to a schematic illustration, the construction of a preform 3. The fibre ribbons 2, 2′ are thereby fixed by a mounting 4 and an expanding wedge 5.

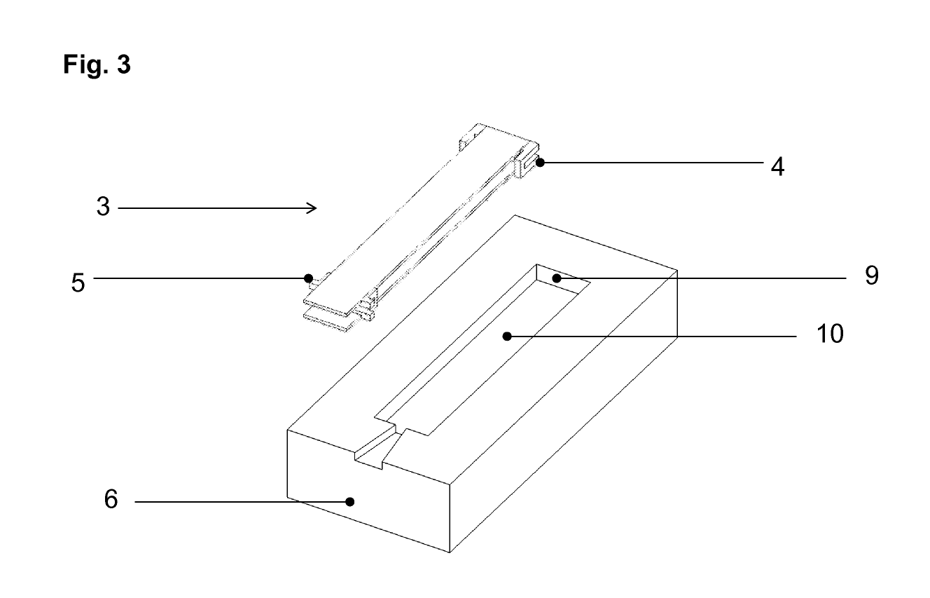

FIG. 3 shows, with reference to a schematic illustration, insertion of a preform 3 into an injection moulding die 6. The preform 3 is thereby placed in the injection moulding die 6 such that the mounting 4 comes to lie on the side of the injection moulding die, situated opposite the melt channel 7, the outflow end 9. The lower side of the preform 3 abuts against the lower inner side face 10 of the injection moulding die 6.

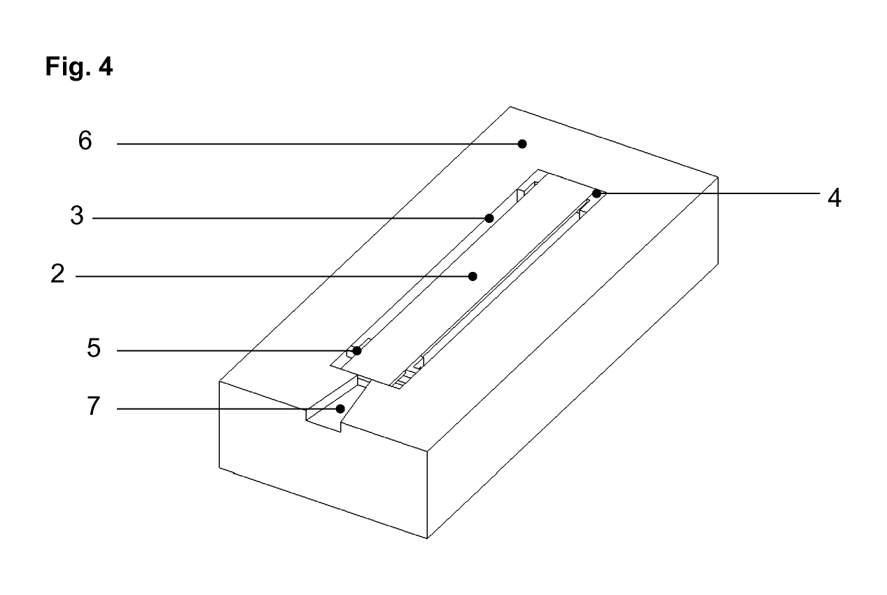

FIG. 4 shows, with reference to a schematic illustration, a preform 3 placed in an injection moulding die 6. The expanding wedge 5 is thereby situated in its initial position in the first half of the fibre ribbon 2, viewed from the melt channel 7.

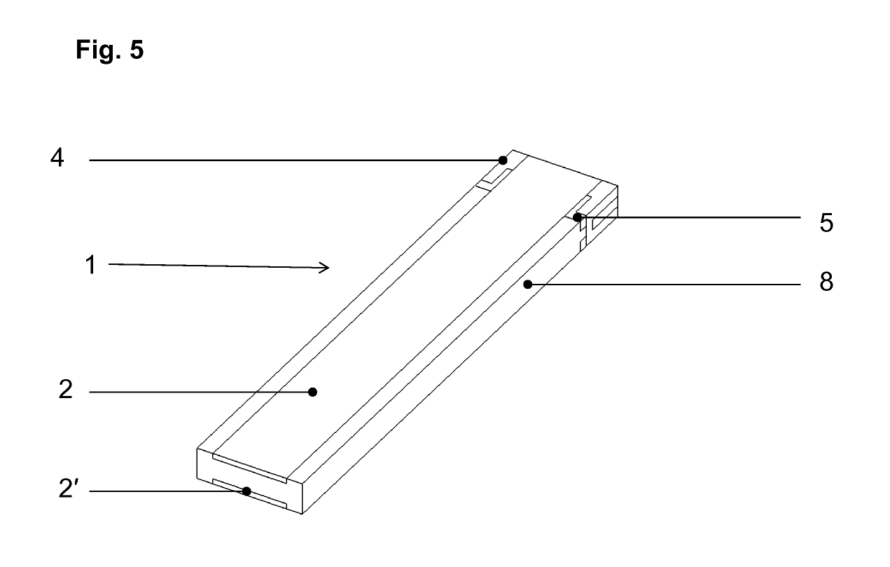

FIG. 5 shows, with reference to a schematic illustration, the construction of a moulding 1 produced according to the method according to the invention. The expanding wedge 5 is situated in its end position adjacent to the mounting 4 into which it was pushed by the second plastic material matrix 8.

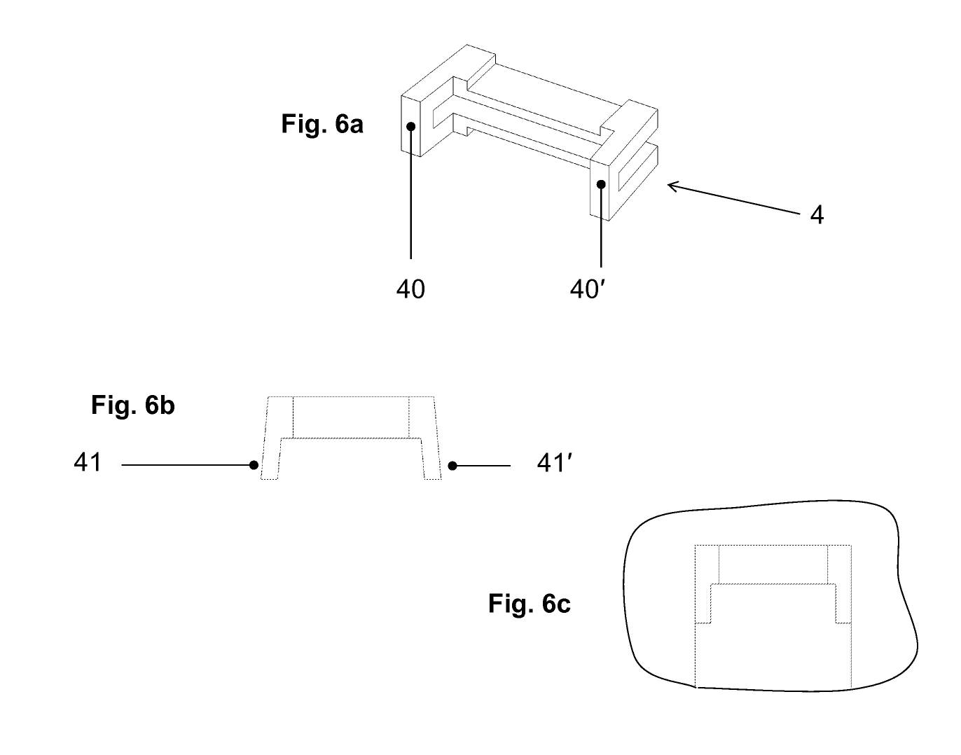

FIG. 6 shows, with reference to a schematic illustration, possible constructions of mountings 4. FIG. 6a shows a mounting 4 with prestressed linkages 40, 40′ which ensure elastic centring of the preform 3 relative to the injection moulding die 6. FIG. 6b shows a mounting with lateral support arms 41, 41′ which ensure a captive elastic positioning of the preform 3 in the injection moulding die 6. It emerges from FIG. 6b that the support arms 41, 41′ are pre-bent towards the outside. FIG. 6c shows a mounting 4 placed in the injection moulding die 6.

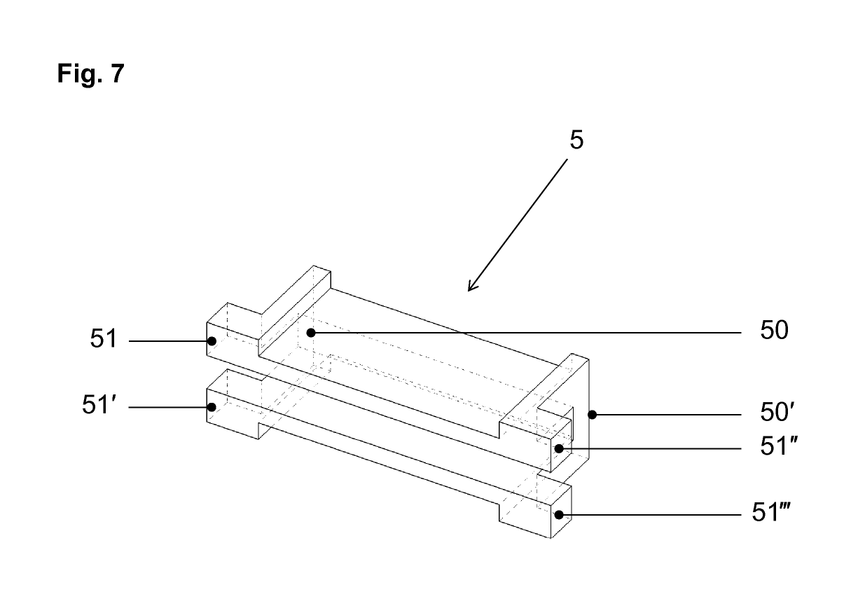

FIG. 7 shows, with reference to a schematic illustration, the construction of an expanding wedge 5 which can be produced via injection moulding- or rapid prototyping methods. The expanding wedge has prestressed linkages 50, 50′ and also centring knobs 51, 51′, 51″, 51″′ which ensure secure vertical and lateral guidance of the fibre ribbons 2, 2′ relative to the injection moulding die 6.

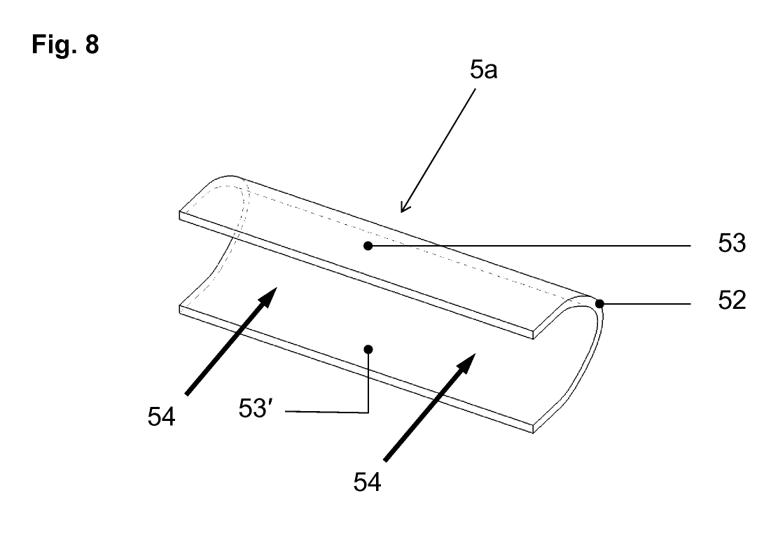

FIG. 8 shows, with reference to a schematic illustration, the construction of an expanding wedge (5a) which can be produced via extrusion methods. The expanding wedge (5a) comprises the prestressed linkage 52 and the support surfaces 53, 53′ against the fibre ribbons 2 and the cavity surfaces of the injection moulding die 6. The second plastic material matrix 8 thereby flows in from direction 54.

Furthermore, the subject according to the invention is intended to be explained in more detail with reference to the subsequent example and comparative example without wishing to restrict said subject to the specific embodiments shown here.

In Table 1, the chemicals used for the examples and the comparative example are cited.

TABLE 1

| Material | Trade name | Supplier |
|---|---|---|
| PA MACM 12 | Grilamid TR90 | EMS-CHEMIE AG (CH) |
| Fibre ribbon | Grilamid LCT-30^{a} | EMS-CHEMIE AG (DE) |

^{a}This concerns a fibre ribbon with a matrix made of PA12 and carbon fibres as reinforcing means.

Production of the tensile test bar made of PA MACM 12 TR90 (CE1)

MACM 12 was obtained from EMS-CHEMIE AG and the ISO test pieces were injected on an injection moulding machine Engel e-Victory 120 at cylinder temperatures of 250° C. to 260° C. of zones 1 to 4 and with a die temperature of 80° C.

Production of the tensile test bar made of Grilamid TR90 (E1) reinforced according to the method according to the invention

A preform according to FIG. 2 made of Grilamid LCT-30 and a mounting produced via rapid prototyping according to FIG. 6 and an expanding wedge produced via rapid prototyping according to FIG. 7 were produced and placed in an injection moulding die according to FIG. 4. Thereafter, MACM 12 was injected on an injection moulding machine Engle e-Victory 120 at cylinder temperatures of 250° C. to 260° C. of zones 1 to 4 and with a die temperature of 80° C., a reinforced ISO test piece being obtained.

The mechanical properties indicated in Table 2 were determined as follows.

Determination of the modulus of tension

Determination of the modulus of tension was effected according to ISO 527 and with a tensile speed of 1 mm/min on an ISO tensile test bar according to the standard ISO 3167, type A with the dimensions 170×2010×4 mm at a temperature of 23° C.

Determination of the breaking strength

Determination of the breaking strength was effected according to ISO 527 with a tensile speed of 5 mm/min on an ISO tensile test bar according to the standard ISO 3167, type A with the dimensions 170×2010×4 mm at a temperature of 23° C.

TABLE 2
Mechanical properties

| | E1 | CE1 |
|---|---|---|
| Modulus of tension [MPa] | 10,000 | 1,600 |
| Breaking strength [MPa] | 200 | 160 |

1. A method for the production of a moulding having at least one reinforcement by means of fibres which are orientated unidirectionally and embedded in a first plastic matrix, having the following steps:
a) providing a preform comprising at least one fibre ribbon, a mounting being fitted in the longitudinal direction of the at least one fibre ribbon at one end and, at the other end, at least one fixing unit which is moveable along the longitudinal direction of the at least one fibre ribbon being fitted,
b) inserting and fixing the preform in an injection moulding die, the end with the mounting being disposed at the outflow end of the injection moulding die,
c) injecting a second plastic matrix through the melt channel so that the fixing unit is transported by the melt flow to the other end of the preform and also
d) cooling and hardening the moulding.

2. The method according to claim 1,
wherein the fixing unit is disposed such that the at least one fibre ribbon abuts against an inner side face of the injection moulding die and the fixing unit is guided during the injection such that the second plastic matrix and the at least one fibre ribbon are connected to each other over the whole surface and in a planar manner and the at least one fibre ribbon forms a surface of the moulding at least in regions.

3. The method according to claim 1,
wherein the fixing unit is disposed such that two fibre ribbons abut against oppositely situated inner side faces of the injection moulding die and the fixing unit is guided during the injection such that the second plastic matrix and the fibre ribbons are connected to each other over the whole surface and in a planar manner and the two fibre ribbons form oppositely situated surfaces of the moulding at least in regions.

4. The method according to claim 1,
wherein the fixing unit is fitted in the first half of the longitudinal portion of the fibre ribbons which is situated opposite the end with the mounting.

5. The method according to claim 1,
wherein the first and/or second plastic matrix is selected from the group consisting of acetal resins, liquid-crystalline polymers, polyacrylates, polymethacrylates, olefinic and cycloolefinic polymers, polyamides, polyamide elastomers, polyester amides, polyether amides and polyether ester amides, polyamide imides, polyarylethers comprising polyphenylethers, polycarbonates, polysulphones, polyetherimides, polyimides, polyesters, polyester polycarbonates, polyethers, polyoxyethylenes, polystyrene, polysulphones, vinyl polymers, polyvinylchloride and polyvinylacetate, or mixtures of one or more of the listed materials.

6. The method according to claim 5,
wherein the first and/or second plastic matrix has a melting point in the range of 50 to 500° C., the first plastic matrix having a lower melting point by 1 to 300° C., than the second plastic matrix.

7. The method according to claim 1,
wherein the fixing unit is selected from the group consisting of an expanding wedge, block-, plug- and arrow-shaped fixing units which comprise a spring element.

8. The method according to claim 1,
wherein the fixing unit and the mounting consist of the same material.

9. The method according to claim 1,
wherein the part of the moulding comprising the fixing unit and the mounting, after hardening, is separated by means of cutting, sawing, squeezing, bending, laser treatment, water jets or combinations thereof.

10. A fibre-reinforced injection moulding comprising at least one fibre ribbon made of fibres which are embedded unidirectionally in a first plastic matrix and also at least one second plastic matrix, at least one surface of the moulding being formed from the at least one fibre ribbon at least in regions.

11. The moulding according to claim 10,
wherein the fibre ribbons comprise endless fibres or staple fibres.

12. The moulding according to claim 10,
wherein the fibre ribbons have a thickness of 0.1 to 5 mm, and/or a width of 1 to 40 mm.

13. The moulding according to claim 10,
wherein the moulding, on two oppositely situated surfaces, has respectively at least one fibre ribbon at least in regions, the spacing of the fibre ribbons relative to each other being the same or different.

14. The moulding producible according to the method of claim 1.

15. A method for the production of automobile parts, running gear components, struts, interior parts, exterior parts, transmission components and rims; industrial and consumer goods, levers, fixings, garden appliances, tools, household appliances, sanitary components, racquets, bows and footwear comprising utilizing the moulding according to claim 10.

16. The method according to claim 6, wherein the first and/or second plastic matrix has a melting point in the range of 170 to 400° C.

17. The method according to claim 7, wherein the spring element is an expanding wedge.

18. The method according to claim 8, wherein the fixing unit and the mounting consist of the same material as of the first and/or second plastic matrix.

19. The moulding according to claim 11, wherein the endless fibres or staple fibres are carbon, glass, mineral or aramide fibers.

20. The moulding according to claim 12, wherein the fibre ribbons have a thickness of 0.2 to 2 mm.
